(19) United States
(12) Patent Application Publication
(10) Pub. No.: US 2024/0371579 A1
(43) Pub. Date: Nov. 7, 2024

(54) Button Structure

(71) Applicant: PERATECH HOLDCO LTD, Catterick Garrison, North Yorkshire (GB)

(72) Inventors: Zhang WEN, Jiansu (CN); Xu FENG, Jiansu (CN); Wei XIN, Jiansu (CN); Cao JIN, Jiansu (CN); You DAWEI, Jiansu (CN); Lv BING, Jiansu (CN); Li ZEFENG, Jiansu (CN); Wang SHICHAO, Jiansu (CN)

(21) Appl. No.: 18/686,765

(22) PCT Filed: Aug. 25, 2021
(86) PCT No.: PCT/GB2022/000072

§ 371 Date: Feb. 26, 2024

(30) Foreign Application Priority Data
Aug. 25, 2021 (CN) 202110980181.9

(51) Int. Cl. H01H 3/12; G06F 3/02; H01H 13/7073

(52) U.S. Cl. CPC H01H 3/125; G06F 3/0219; H01H 13/7073; H01H 2201/02

(57) ABSTRACT

A button structure comprises a keycap, an elastic body, a scissor mechanism, and a piezoresistive film sensor arranged on a support plate. The scissor mechanism and the elastic body are arranged between the keycap and the piezoresistive film sensor. The piezoresistive film sensor comprises a first pressure sensing area and a second pressure sensing area. The elastic body corresponds to the first pressure sensing area and the scissor mechanism corresponds to the second pressure sensing area, such that, when a pressure is applied to the keycap, a first pressure acts on the elastic body to generate pressure on the first pressure sensing area and a second pressure acts on the scissor mechanism to generate pressure on the second pressure sensing area.

### CROSS REFERENCE TO RELATED APPLICATIONS

This application claims priority from Chinese Patent Application number 202110980181.9, filed on 25 Aug. 2021, the whole contents of which are incorporated herein by reference.

### TECHNICAL FIELD

The present invention relates to a button structure and a keyboard comprising a button structure.

### BACKGROUND OF THE INVENTION

Pressure sensing electronic keyboards, such as those utilized with electronic devices such as personal computers are known in the art. To provide a pressure-sensing electronic keyboard a pressure sensing module is added under the keys to sense the pressure with which multiple keys are touched by a user. A corresponding signal is then output according to the magnitude of the force on the pressure-sensing module.

At present, existing pressure sensing buttons rely on a silicone elastomer in the button to exert force on the pressure sensing module to perform pressure detection. In this way, existing designs rely solely on the silicone elastomer to determine pressure detection and the force application point does not accurately reflect the user's pressure on the button. Consequently, the accuracy of the touch force detected by the pressure sensing module is low.

There remains a need to provide a button structure and a keyboard thereof to address the above problems.

CN 210 575 663 U (SUNREX TECHNOLOGY CORP) 19 May 2020 describes a key device for a keyboard. The keyboard comprises a sensing module, a key cap, two side pressing modules, two scissor foot modules and a main pressing module. The key cap can be smoothly sensed when being pressed at any position.

### BRIEF SUMMARY OF THE INVENTION

According to a first aspect of the present invention, there is provided a button structure.

Embodiments of the invention will be described, by way of example only, with reference to the accompanying drawings. The detailed embodiments show the best mode known to the inventor and provide support for the invention as claimed. However, they are only exemplary and should not be used to interpret or limit the scope of the claims. Their purpose is to provide a teaching to those skilled in the art. Components and processes distinguished by ordinal phrases such as “first” and “second” do not necessarily define an order or ranking of any sort.

### BRIEF DESCRIPTION OF THE SEVERAL VIEWS OF THE DRAWINGS

FIG. 1 shows an electronic device and keyboard comprising a button structure;

FIG. 2 shows a first structural schematic diagram of a button structure provided by an embodiment of the present invention;

FIG. 3 shows a second structural schematic diagram of a button structure provided by an embodiment of the present application;

FIG. 4 shows a schematic structural diagram of a scissor mechanism provided in an embodiment of the present application;

FIG. 5 shows is a third structural schematic diagram of a button structure provided by an embodiment of the present application;

FIG. 6 shows a fourth schematic structural diagram of a button structure provided by an embodiment of the present application;

FIG. 7 shows a schematic structural diagram of an elastic body provided in an embodiment of the present application; and

FIG. 8 shows a fifth structural schematic diagram of a button structure provided by an embodiment of the present application.

### DETAILED DESCRIPTION OF EMBODIMENTS OF THE INVENTION

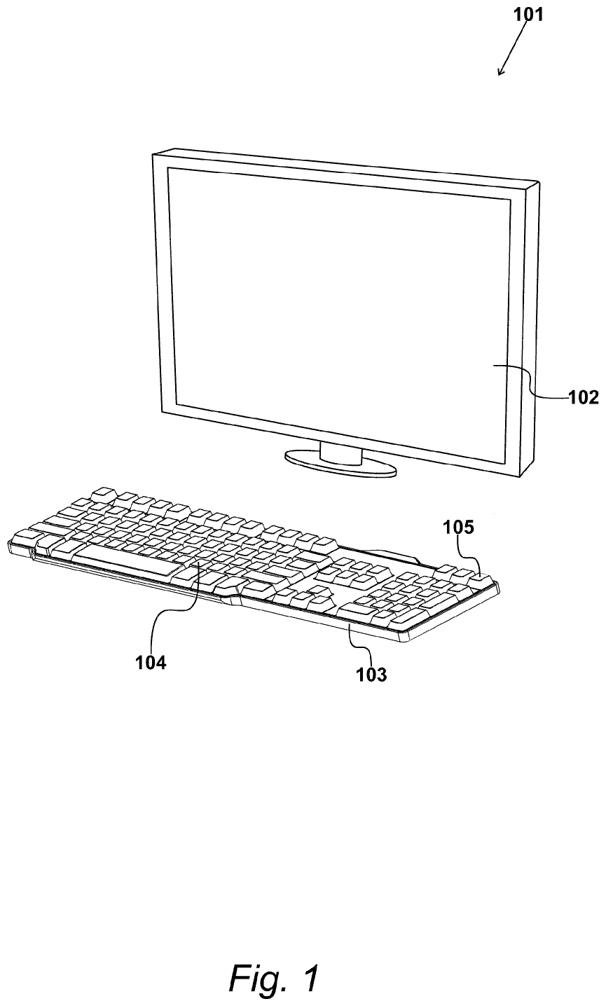

### FIG. 1

An electronic device 101 is shown in FIG. 1 comprising a personal computer comprising a display 102 and keyboard 103. Keyboard 103 comprises a plurality of keys 104 configured to receive an applied pressure from a user to activate a user input to enable control of electronic device 101.

In the embodiment, keyboard 103 comprises a plurality of keys each having a button structure in accordance with the present invention. In the embodiment, key 105 comprises such a button structure as described herein such that a user can provide an applied pressure to key 105 and the pressure applied can be detected by means of the button structure.

Keyboard 103 is therefore configured to comprise any of the embodiments of the button structures described herein. As will now be described further, the button structure of the present invention utilizes two pressure sensing areas to detect pressure on a scissor mechanism and an elastic body, such that the pressure detected by a piezoresistive film sensor is the combination of the pressure of the scissor mechanism and the pressure of the elastic body. This provides a button structure which more accurately reflects an external force applied to a keycap.

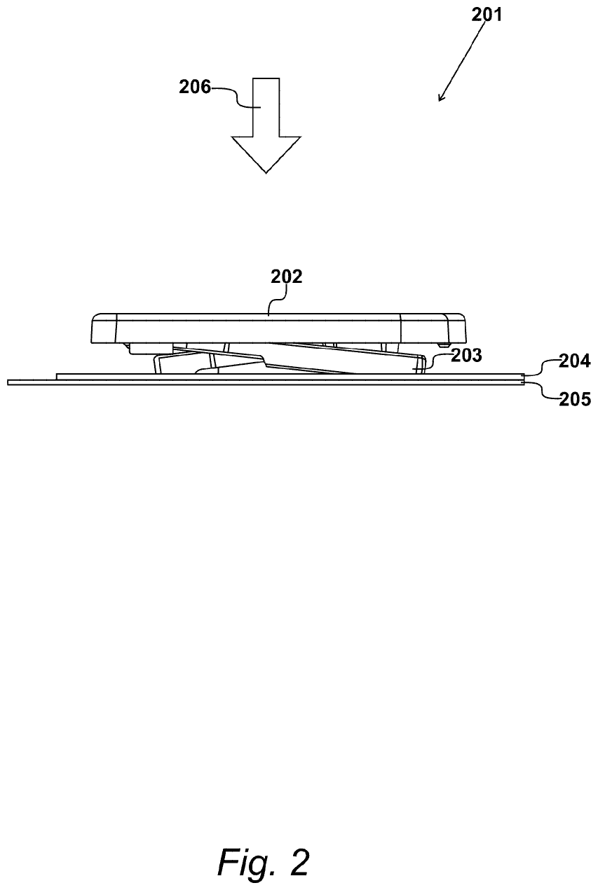

### FIG. 2

An embodiment of the present application provides key 105 with a button structure 201, which is shown in a schematic side view in FIG. 1. Button structure 201 comprises a keycap 202, a scissor mechanism 203, a piezoresistive film sensor 204 and a support plate 205. Piezoresistive film sensor 204 is arranged on support plate 205 and scissor mechanism 203 is arranged between keycap 202 and piezoresistive film sensor 204.

In the embodiment, when keycap 202 receives an external pressure 206, for example, when keycap 202 is pressed by a user's finger, keycap 202 is configured to move in a vertical direction relative to support plate 205, in the direction of arrow 206, through scissor mechanism 203.

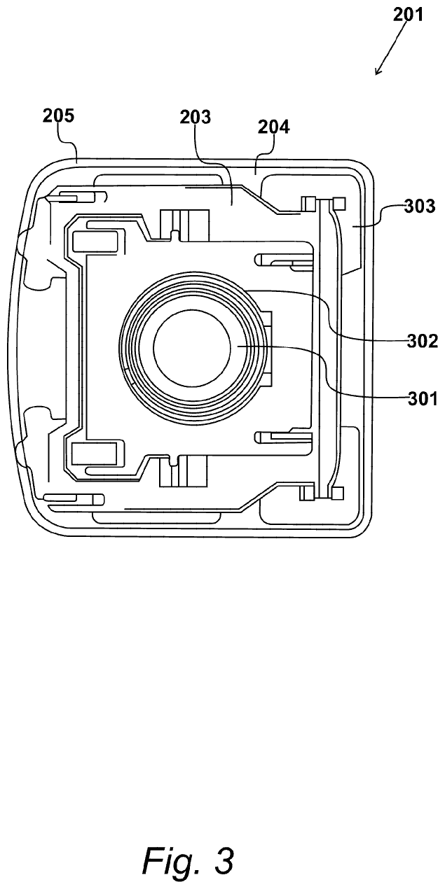

With the movement of keycap 202, scissor mechanism 203 also moves and is brought into contact with piezoresistive film sensor 204. This process will be explained further with respect to FIG. 3.

### FIG. 3

Button structure 201 is shown in a further schematic plan view in FIG. 3. Button structure 201 comprises an elastic body 301, scissor mechanism 203, piezoresistive film sensor 204 and support plate 205.

In the illustration of FIG. 3, it is appreciated that keycap 202 is not shown, but is configured to overlay elastic body 301, such that, when force 206 is applied to keycap 202, contact with elastic body 301 can be made. Similarly, referring to FIG. 2, it is appreciated that elastic body 301 is present under keycap 202 and obscured in the illustration by scissor mechanism 203.

In the embodiment, both scissor mechanism 203 and elastic body 301 are arranged between keycap 202 and piezoresistive film sensor 204. Piezoresistive film sensor 204 comprises a first pressure sensing area 302 and a second pressure sensing area 303. In the embodiment, elastic body 301 corresponds to first pressure sensing area 302, and scissor mechanism 203 corresponds to second pressure sensing area 303.

Thus, when keycap 202 receives an external pressure, such, as for example, external pressure 206 described previously, keycap 202 moves in the direction of arrow 206 through scissor mechanism 203. With the movement of keycap 202, scissor mechanism 203 moves and contacts piezoresistive film sensor 204 in the second pressure sensing area 303.

Since scissor mechanism 203 corresponds to second pressure sensing area 303, when a sufficient pressure is applied, scissor mechanism 203 touches piezoresistive film sensor 204 and the scissor mechanism 203 and corresponding pressure sensing area 202 exerts a pressure against piezoresistive film sensor 204.

At the same time, with the vertical movement in the direction of arrow 206 of keycap 202, keycap 202 exerts a force on elastic body 301, which, in turn, causes elastic body 301 to interact and be brought into contact with piezoresistive film sensor 204 in the first pressure sensing area 302.

Since elastic body 301 corresponds to first pressure sensing area 302, when a sufficient pressure is applied, elastic body 301 exerts a pressure on first pressure sensing area 302. In this way, first pressure sensing area 302 and second pressure sensing area 303 can be used to detect the applied pressure from both scissor mechanism 203 and elastic body 301. Piezoresistive film sensor 204 is then configured to output an electrical signal corresponding to the pressure of the combination of scissor mechanism 203 and elastic body 301.

In this button structure, this solution not only sets the first pressure sensing area on the piezoresistive film sensor corresponding to the elastic body, but also sets the second pressure sensing area through the piezoresistive film sensor to detect the pressure on the scissor mechanism. The pressure detected by the piezoresistive film sensor is therefore the combination of the pressure from the scissor mechanism and the pressure from the elastic body, and this combination reflects the external force on the keycap. Therefore, the present application enables the piezoresistive thin film sensor to detect changes in force more precisely, thereby improving the accuracy of the piezoresistive thin film sensor in detecting and identifying the magnitude of the force.

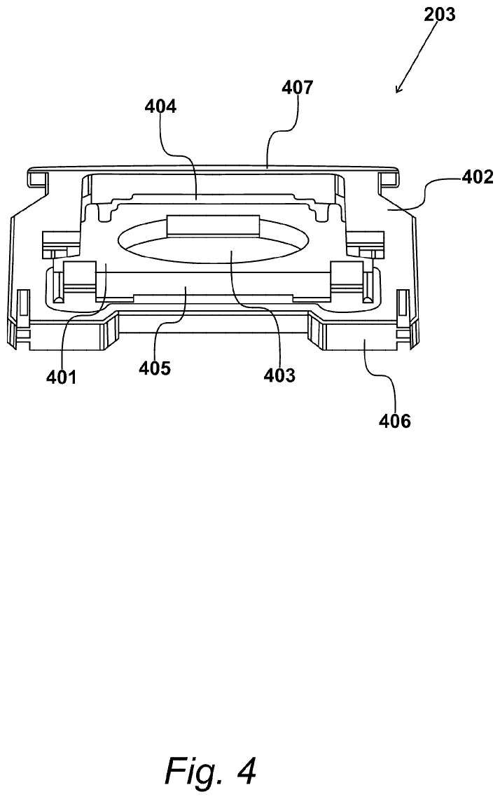

### FIG. 4

An example embodiment of scissor mechanism 203 is shown in isolation in FIG. 4.

In the embodiment, scissor mechanism 203 comprises an inner scissor leg 401 and an outer scissor leg 402. Inner scissor leg 401 and outer scissor leg 402 are rotatably connected about a center point 403. In this way, the scissor mechanism is configured to pivot in a conventional manner, such that, when attached to the keycap 202, keycap 202 can move upwards and downwards in a vertical direction in response to an applied force or pressure.

Inner scissor leg 401 comprises a first edge 404 and a second edge 405. First edge 404 and second edge 405 are substantially opposite to each other.

Outer scissor leg 402 comprises a third edge 406 and a fourth edge 407. Third edge 406 and fourth edge 407 are substantially opposite to each other.

In the embodiment, when formed as part of button structure 201, edge 404 and edge 406 are both connected to piezoresistive film sensor 204. In addition, edge 405 and edge 407 are both connected to keycap 202.

When a force is applied to keycap 202, keycap 202 exerts pressure on edge 405 and edge 407, due to the rotation about center point 403 of inner scissor leg 401 and outer scissor leg 402. As inner scissor leg 401 and outer scissor leg 402 are connected, edge 405 and edge 407 gradually lower on application of such a force until they are brought into contact with piezoresistive film sensor 204.

Based on the structure of scissor mechanism 203, second pressure sensing area 303 is corresponds to edge 405 and edge 407. In this way, when a pressure is applied to keycap 202, edge 405 and 407 are brought into contact with the second pressure sensing area 303 of piezoresistive film sensor 204. Thus, edge 405 and edge 407 generate a pressure on second pressure sensing area 303 which is then detected by piezoresistive film sensor 204.

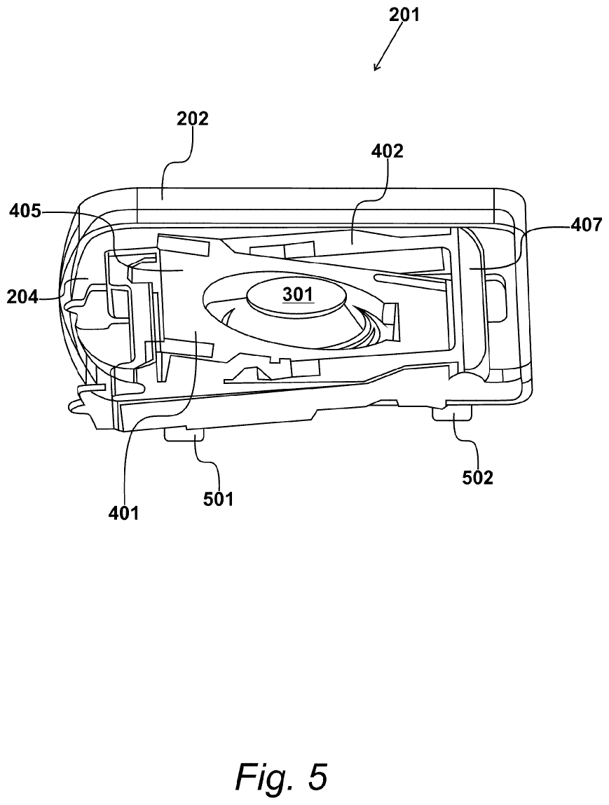

### FIG. 5

A schematic of button structure 201 is shown in FIG. 5. In this example embodiment, second pressure sensing area 303 comprises a first elongate sensing area 501 and a second elongate sensing area 502.

In the embodiment, elongate sensing area 501 corresponds to edge 405 of inner scissor leg 401 and elongate sensing area 502 corresponds to edge 407 of outer scissor leg 402. Thus, a pressure applied to edge 405 is transmitted to elongate sensing area 501 and is consequently detected by piezoresistive film sensor 204.

In addition, a pressure applied to edge 407 is transmitted via elongate sensing area 502 to piezoresistive film sensor 204 and consequently detected by piezoresistive film sensor 204.

In an example embodiment, both outer scissor legs 402 and inner scissor leg 401 comprise a hollow portion. Inner scissor leg 301 is arranged both in the hollow portion of the outer scissor leg and the elastic body 301.

Consequently, the shape of the hollow portion of the outer scissor leg 402 is adapted to the shape of the inner scissor leg 401 and the shape of the hollow portion of the inner scissor leg 401 is adapted to the shape of elastic body 301.

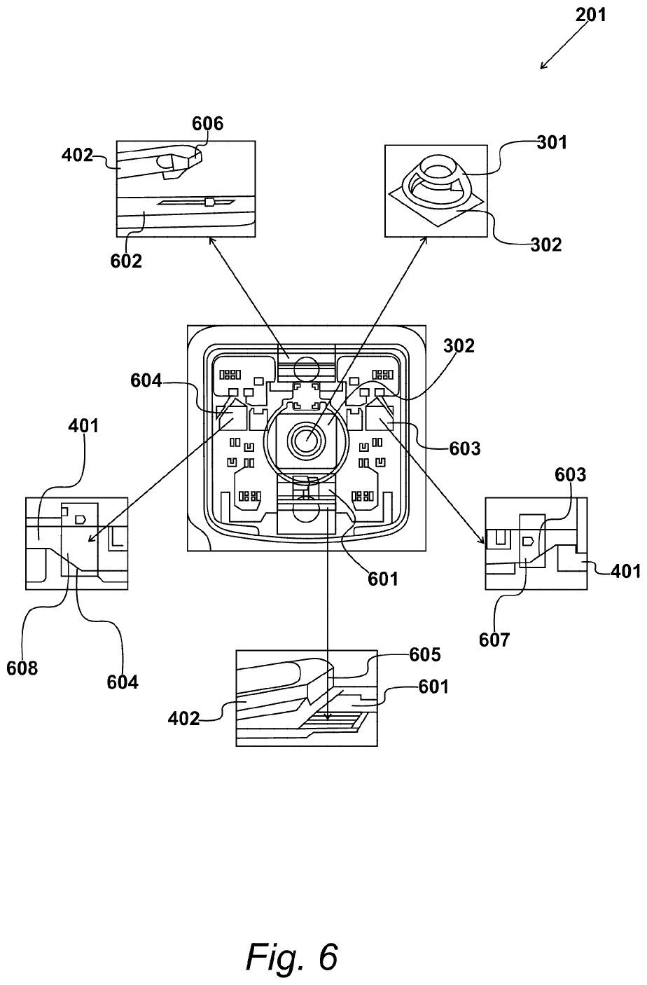

### FIG. 6

An alternative view of button structure 201 is show in plan view with detail views of components of the described embodiments is shown in FIG. 6.

In the embodiment, inner scissor leg 401 and outer scissor leg 402 each comprise a quadrilateral bracket. Second pressure sensing area 303 comprises a first contact sensing area 601, a second contact sensing area 602, a third contact sensing area 603 and a fourth contact sensing area 604.

In the embodiment, a first corner 605 and a second corner 606 of the fourth edge 407 of the outer scissor leg 402 correspond and are respectively connected to first contact sensing area 601 and second contact sensing area 602.

In addition, a third corner 607 and a fourth corner 608 of the second edge 405 of inner scissor leg 401 correspond and are consequently respectively connected to third contact sensing area 603 and fourth contact sensing area 604.

As described previously, elastic body 301 corresponds to first pressure sensing area 302 as shown.

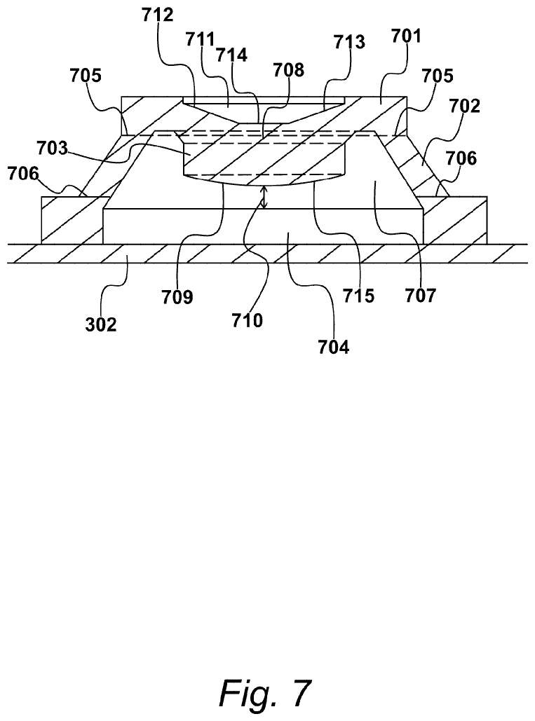

### FIG. 7

Elastic body 301 is shown in isolation in FIG. 7 in schematic side view. In the embodiment, elastic body 301 comprises a top portion 701, a ring wall 702, a transmitting column 703 and a bottom portion 704.

In the embodiment, a first end 705 and a second end 706 of ring wall 702 are respectively connected to top portion 701 and bottom portion 704 inside ring wall 702 to form a cavity 707. Cavity 707 is therefore formed within ring wall 702.

Transmitting column 703 is located in cavity 707 and is arranged between top portion 701 and bottom portion 704. An upper end 708 of transmitting column 703 is connected to top portion 701 and a lower end 709 of transmitting column 703, opposite to upper end 708, is spaced a predetermined distance 710 from bottom portion 704. Bottom portion 704 is connected to first pressure sensing area 302.

In the elastic body 301, the force of the keycap 202 acts on top portion 701 of elastic body 301, and, when top portion 701 receives an applied force, transmitting column 703 is driven within ring wall 703 to move in a downward direction in line with the applied force, such that transmitting column 703 is brought towards bottom portion 704. When transmitting column 703 contacts bottom portion 704, a downward force is exerted on bottom portion 704 to generate a pressure on first pressure sensing area 302 of the piezoresistive thin film sensor 204 which is connected to bottom portion 704.

In the embodiment, a recessed space 711 is further defined on top portion 701 of elastic body 301. Recessed space 711 comprises a first side wall 712, a second side wall 713 and a recessed bottom wall 714.

Side wall 712 and side wall 713 are distributed at opposite ends of recessed bottom wall 714 and are respectively connected with recessed bottom wall 714.

Side wall 712, side wall 713 and recessed bottom wall 714 form an obtuse angle, with a first obtuse angle between side wall 712 and recessed bottom wall 714, and a second obtuse angle between side wall 713 and recessed bottom wall 714, that is, each angle is greater than ninety degrees) (90°). In this way, recessed space 711 is concave.

For the elastic body 301, since the angle in recessed space 711 is an obtuse angle, when elastic body 301 is deformed under pressure, recessed space 711 of top portion 701 provides an increased buffer space for transmitting column 703 to descend, such that the downward stroke of elastic body 301 is free from the space limitation found in conventional notebook keyboards. This further allows for additional transmission of force to be formed, so that elastic body 301 reaches the stroke end point within the specified stroke of a given key press.

In use, elastic body 301 is elastically deformed by force under the action of keycap 202, and top portion 701 and transmitting column 703 of elastic body 301 gradually moves downwards, that is, towards the position of first pressure sensing area 302 of piezoresistive film sensor 204. Due to the elasticity of elastic body 301 and the limitation of the internal space of the keyboard, second side wall 713 and ring wall 702 are deformed correspondingly due to the force, and ring wall 702 also contacts the position of the first pressure sensing area 302 of piezoresistive film sensor 204. When the external force is released, elastic body 301 is restored to its initial state by the elastic restoring force of the elastic body itself.

In an optional implementation of this embodiment, as illustrated in FIG. 7, the bottom surface 715 of transmitting column 703 of elastic body 301 is substantially arc shaped.

By providing an arc shaped bottom surface, even if transmitting column 703 is subjected to an inclined downward displacement, the shape ensures that there is sufficient contact area and triggering force between transmitting column 703 and first pressure sensing region 302 of piezoresistive thin film sensor 204 to provide an input signal. Thus, elastic body 301 achieves the effect of input stability.

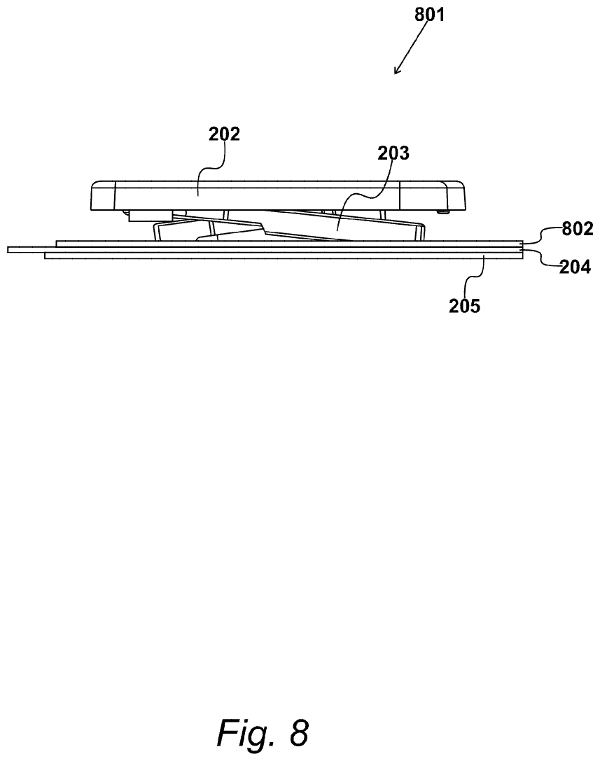

### FIG. 8

FIG. 8 shows an alternative embodiment of the button structure to that described previously in that the button structure 801 of FIG. 8 further comprises a thin film circuit layer 802. It is appreciated that the remaining features of button structure 801 are substantially similar to those described previously and are numbered accordingly.

In this embodiment, thin film circuit layer 802 is disposed on piezoresistive thin film sensor 204 such that, when thin film circuit layer 802 is provided, elastic body 301 and scissor mechanism 203 are disposed on thin film circuit layer 802, with keycap 202 thereon as described previously. Thin film circuit layer connects elastic body 301 to inner scissor leg 401 and outer scissor leg 402. Thus, thin film circuit layer 802 can transmit pressure generated by elastic body 301 and scissor mechanism 203 to piezoresistive thin film sensor 204.

In the embodiment, thin film circuit layer 802 comprises an electrical circuit, the electrical circuit is connected to piezoresistive thin film sensor 204 and is configured to collect a resistance value converted from the pressure applied to piezoresistive thin film sensor 204 and output a corresponding electrical signal.

In the embodiments of the button structures described herein, the solution not only sets a first pressure sensing area on the piezoresistive film sensor to correspond to the elastic body, but also sets a second pressure sensing area through the piezoresistive film sensor to detect the pressure on the scissor mechanism. In this way, the pressure detected by the piezoresistive film sensor is the combination of the pressure on the scissor mechanism and the pressure on the elastic body. This combination of the pressure on the scissor mechanism and the pressure on the elastic body reflects well the external force on the keycap. Thus, the present application enables the piezoresistive thin film sensor to detect force changes more accurately thereby improving the accuracy of the piezoresistive thin film sensor in detecting and identifying the magnitude of the force.

1. A button structure, comprising:
a keycap;
an elastic body;
a scissor mechanism comprising an inner scissor leg and an outer scissor leg; and
a piezoresistive film sensor arranged on a support plate;
said scissor mechanism and said elastic body are arranged between said keycap and said piezoresistive film sensor;
said piezoresistive film sensor comprises a first pressure sensing area and a second pressure sensing area; wherein
said elastic body corresponds to said first pressure sensing area and said scissor mechanism corresponds to said second pressure sensing area, such that, when a pressure is applied to said keycap, a first pressure acts on said elastic body to generate pressure on said first pressure sensing area; and
a second pressure acts on said scissor mechanism to generate pressure on said second pressure sensing area; and
said button structure further comprises a thin film circuit layer;
said thin film circuit layer is disposed on said piezoresistive thin film sensor and connects said elastic body to said inner scissor leg and said outer scissor leg; and
said thin film circuit layer is configured to transmit an applied pressure to said piezoresistive film sensor.

2. The button structure of claim 1, wherein
said inner scissor leg and said outer scissor leg are rotatably connected about a center point.

3. The button structure of claim 1, wherein said inner scissor leg comprises a hollow portion, and said elastic body is disposed between said piezoresistive film sensor and said keycap through said hollow portion.

4. The button structure of claim 1, wherein said elastic body comprises a top portion, a ring wall, a transmitting column and a bottom portion,
a first end and a second end of said ring wall are respectively connected to said top portion and said bottom portion inside said ring wall to form a cavity;
said transmitting column is located in said cavity and is arranged between said top portion and said bottom portion, an upper end of said transmitting column is connected to said top portion, and a lower end of said transmitting column opposite to said upper end is spaced a predetermined distance from said bottom portion; and
said bottom portion is connected to said first pressure sensing area.

5. The button structure of claim 4, wherein a recessed space is defined on said top portion;
said recessed space comprising a first side wall, a second side wall and a recessed bottom wall, said first side wall and said second side wall are respectively connected to said recessed bottom wall; and
said first side wall, said second side wall and said recessed bottom wall form an obtuse angle.

6. A keyboard comprising the button structure of claim 1.

7. An electronic device comprising the keyboard of claim 6.

8. The button structure of claim 2, wherein said inner scissor leg comprises a first edge and a second edge, said first edge and second edge are substantially opposite to each other; and
said outer scissor leg comprises a third edge and a fourth edge, said third edge and said fourth edge are substantially opposite to each other; wherein
said first edge and said third edge are connected to said piezoresistive film sensor, and said second edge and said fourth edge are connected to said keycap.

9. The button structure of claim 8, wherein said second pressure sensing area corresponds to said second edge of said inner scissor leg and said fourth edge of said outer scissor leg.

10. The button structure of claim 8, wherein said second pressure sensing area comprises a first elongate sensing area and a second elongate sensing area, said first elongate sensing area corresponding to said second edge of said inner scissor leg and said second elongate sensing area corresponding to said fourth edge of said outer scissor leg.

11. The button structure of claim 9, wherein said outer scissor leg and said inner scissor leg each comprise a quadrilateral bracket; and
said second pressure sensing area comprises a first contact sensing area, a second contact sensing area, a third contact sensing area, and a fourth contact sensing area; wherein
a first corner and a second corner of said fourth edge of said outer scissor leg correspond to said first contact sensing area and second contact sensing area, respectively; and
a third corner and a fourth corner of said second edge of said inner scissor leg correspond to said third contact sensing area and the fourth contact sensing area, respectively.

12. A keyboard comprising the button structure of claim 2.

13. A keyboard comprising the button structure of claim 3.

14. A keyboard comprising the button structure of claim 4.

15. A keyboard comprising the button structure of claim 5.
